(19) United States
(12) Patent Application Publication
(10) Pub. No.: US 2006/0085429 A1
(43) Pub. Date: Apr. 20, 2006

(54) Acknowledged delivery of full email state change to mobile email clients after involuntary disconnects

(75) Inventors: Michael J. Wener, Munising, MI (US); David Scott DeCamp, Arlington, TX (US)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 11/174,291

(22) Filed: Jun. 30, 2005

Related U.S. Application Data
(60) Provisional application No. 60/619,067, filed on Oct. 15, 2004.

(51) Int. Cl. G06F 17/30

(52) U.S. Cl. 707/10

(57) ABSTRACT

The present invention provides that while a mobile device is connected in an IDLE session on an IMAP mail server the mail client will be able to provide definite acknowledgements to the server as to whether it has received a particular response. If the client is disconnected involuntarily and upon reconnection it will be able to receive any responses that it may have missed during its disconnection and any response it had not acknowledged while connected. This will allow the client to thus avoid doing a deep synchronization after each reconnect. The present invention performs two main functions in order to avoid having the client perform deep synchronization. One, it clearly defines the set of information sent to the client during a reconnection, and two, it defines the behaviour that both the server and the client have during an involuntary loss of connection and the subsequent reconnection. There are numerous advantages to the invention including that it provides a way to avoid a deep synchronization after each involuntary disconnect.

### FIELD OF INVENTION

The invention extends existing mail access technologies. Specifically it extends the IMAP protocol and can be used in a broad range of Mobile e-mail clients.

### BACKGROUND OF THE INVENTION

Mobile clients need a way to maintain mailbox state information with out performing deep synchronizations in the event of a lost connection.

The prior art approach to solving this is to perform deep synchronizations at each connection of the client to server. The synchronization algorithm requires a client to connect to the sever and perform a potentially N squared algorithm to find out the state needed. The synchronization is time consuming.

A solution to handle lost connections is proposed by the Internet Society and is included in the Lemonade profile and Lemonade server-to-client notification protocols which allows clients to submit new email messages incorporating content which resides on locations external to the client (“forward without download”) and to optimize e-mail exchanges between clients and servers in a mobile environment. This approach relies upon extensions to other protocols; specifically URLAUTH, CATENATE, Lemonade Command Extensions in the IMAP protocol [RFC 3501] and BURL in the SUBMIT protocol [RFC 2476]. The approach also attempts to provide optimization in a mobile setting, aimed at delivering extended functionality for mobile devices with limited resources by relying on Lemonade Server to Client Notifications to support to push crucial changes actively to a client, rather then requiring the client to initiate contact to ask for state changes. In addition, the Lemonade profile contains Lemonade Command extensions for email filter management, message delivery, maintaining up-to-date personal information and quick reconnect. In the examples, “C:” and “S:” indicate lines sent by the client and server respectively.

The Lemonade Pull Model describes exchanges between Lemonade Agents to allow clients to submit new email messages incorporating content which resides on locations external to the client. The advent of client/server email using the [RFC3501] and [RFC2821] protocols has changed what formerly were local disk operations to become excessive and repetitive network data transmissions. This is an onerous burden for clients operating over low-bandwidth and/or high-latency links. The Lemonade Pull Model makes use of the [BURL] SUBMIT extension to enable access to external sources during the submission of a message. In combination with the IMAP [URLAUTH] extension, inclusion of message parts or even entire messages from the IMAP mail store is possible with a minimal trust relationship between the IMAP and SUBMIT servers. Pull maintains one submission protocol, and thus avoids the risk of having multiple parallel and possible divergent mechanisms for submission. Furthermore, by keeping the details of message submission in the SUBMIT server, the Lemonade Pull Model can work with other message retrieval protocols such as POP, NNTP, or whatever else may be designed in the future.

The act of sending an email message is best thought of as involving multiple steps: initiation of a new draft, draft editing, message assembly, and message submission. Initiation of a new draft and draft editing takes place on the MUA. Frequently, users choose to save more complex and/or time-consuming messages on an [RFC3501] server (via the APPEND command with the \Draft flag) for later recall by the MUA and resumption of the editing process. Message assembly is the process of producing a complete message from the final revision of the draft and external sources. At assembly time, external data is retrieved and inserted in the message. Message submission is the process of inserting the assembled message into the [RFC2821] infrastructure, typically using the [RFC2476] protocol. Traditionally, messages are initiated, edited, and assembled entirely within an MUA, although drafts may be saved to an [RFC3501] server and later retrieved from the server. The completed text is then transmitted to an MSA for delivery.

There is often no clear boundary between the editing and assembly process. If a message is forwarded, its content is often retrieved immediately and inserted into the message text. Similarly, once external content is inserted or attached, the content is usually retrieved immediately and made part of the draft. As a consequence, each save of a draft and subsequent retrieve of the draft transmits that entire (possibly large) content, as does message submission. In the past, this was not much of a problem, because drafts, external data, and the message submission mechanism were typically located on the same system as the MUA. The most common problem was running out of disk quota. The model distinguishes between a Messaging User Agent (MUA), an IMAPv4Rev1 Server ([RFC3501]) and a submit server ([RFC2476]), as illustrated in FIG. 1.

The Lemonade Pull Model allows a Messaging User Agent to compose and forward an e-mail combining fragments that are located in an IMAP server, without having to download these fragments to the server. In the [BURL]/[CATENATE] variant of the pull strategy, messages are initiated and edited within an MUA. The [CATENATE] extension to [RFC3501] is then used to upload the message to the IMAP server and assemble it, and finally a [URLAUTH] format URL is given to a [RFC2476] server with the [BURL] extension for submission.

The flow involved to support such a use case consists of:
M: {to S1—Optional} The client uses IMAP Fetch of body structures (See [RFC3501])
M: {to S1} The client invokes CATENATE (See [CATENATE] for details of the semantics and steps ?s allows the MUA to create messages on the IMAP using new data combined with body structure already present on the IMAP server.
S1: {to M} OK (See [CATENATE]).
M: {to S1} The client uses GENURLAUTH command to request and URLAUTH URL (See [URLAUTH]).
S1: {to M} The IMAP server returns URLAUTH URL suitable for later retrieval with URLFETCH (See [URLAUTH] for details of the semantics and steps).
M: {to S2} The client connects to the submission server and starts a new mail transaction. It uses BURL to let the submit server fetch the content of the message from the IMAP server (See [BURL] for details of the semantics and steps ?s allows the MUA to authorize the submit server to access the message composed as a result of the CATENATE step).
S2: {to S1} The submission server uses URLFETCH to fetch the message to be sent (See [URLAUTH] for details of the semantics and steps. The so-called “pawn-ticket” authorization mechanism uses a URI which contains its own authorization credentials.).
S1: {to S2} Provides the message composed as a result of the CATENATE step).
S2: {to M} OK (2XX)

The messaging user agent, mail server and submit server MUST support IMAPv4 Rev1 [RFC3501], CATENATE [CATENATE] and URLAUTH [URLAUTH]. The so-called “pawn-ticket” authorization mechanism uses a URI which contains its own authorization credentials using [URLAUTH]. The advantage of this mechanism is that the submit [RFC2476] server cannot access any data on the [RFC3501] server without a “pawn-ticket” created by the client. The “pawn-ticket” grants access only to the specific data that the submit [RFC2476] server is authorized to access, can be revoked by the client, and can have a time-limited validity.

The “fcc problem” refers to a frequent need to deliver a copy of the message to a “file carbon copy” recipient. By far, the most common case of fcc is a client leaving a copy of outgoing mail in a “sent messages” or “outbox” mailbox. In the traditional strategy, the MUA duplicates the effort spent in transmitting to the MSA by writing the message to the fcc destination in a separate step. This may be a write to a local disk file or an APPEND to a mailbox on an IMAP server. The latter is one of the “excessive and repetitive network data transmissions” which represents the “problem” aspect of the “fcc problem”. The [CATENATE] extension to [RFC3501] addresses the fcc problem. It requires making several simplifying assumptions:
(1a) there is one, and only one, fcc destination on a single server
(2a) the server which holds the fcc is the same as the server which stages the outgoing message for submission
(3a) it is desired that the fcc be a copy of the complete message text with all external data inserted in the message

Mobile optimizations that defines extensions to the IMAPv4 Rev1 protocol [RFC3501] aimed at delivering extended functionality for mobile devices with limited resources including support to push crucial changes actively to a client, rather then requiring the client to initiate contact to ask for state changes and extensions for email filter management, message delivery, and maintaining up-to-date personal information and quick reconnect.

The Lemonade profile provides optimizations for the exchanges between a mobile client and e-mail server by specifying additional enhancements for optimization in a mobile setting. Thus, the client devices in this profile are assumed to be mobile with limited resources. This profile takes into account the limited resources of mobile devices, as well as extra functionality desired.

FIG. 2 illustrates the exchanges specified by the mobile optimizations of the Lemonade Profile.

A disconnected mobile client should behave like a good disconnected client [IMAP-DISC].

Today, most of the existing email clients have a polling model, where the end user is notified of changes to an email account only after his/her email client asks the server, called polling. How long it takes a client to learn of a change on the server is thus dependent on how often the client polls for changes. Many clients can poll at high rates so that the client can quickly learn of changes and reflect them on the client display to achieve a quasi-real time.

The mobile optimization of the Lemonade profile can support both Poll and Push Models.

Today, most of the existing email clients implement a polling model, where the end user is notified of changes to an email account only after the email client polls the server for changes. How long it takes a client to learn of a change on the server is thus dependent on how often the client polls for changes. Many clients can poll at high rates so that the client can quickly learn of changes and reflect them on the client display to achieve a quasi-real time synchronization experience for the end user. The periodic poll model is used on conventional email clients. Because the client must continuously poll the server for changes, the bandwidth requirements can be quite high and the connection quality must be good in order to provide a quasi-real time experience to the user. This also generates additional load on the IMAP server. The periodic poll model is illustrated in FIG. 3.

Another way to achieve synchronization is for the email server to initiate a session with the client when a crucial change to an email occurs, which is the push model. When important events happen to a user's email account, the server informs the client device about the event, and then the client can respond to that event as necessary. In this case, the client device does not need to periodically poll the mail server, so the push model is particularly effective in the mobile computing environment when the cost of constant polling is high. [NOTIFICATIONS] defines the semantics for pushing events to a client. The push model is seen in FIG. 4.

After a client receives a notification that informs it that changes have occurred to a mailbox, it needs to employ a synchronization technique to reflect the server side changes onto the client device. There are many techniques for determining what the changes between a server and client are. In this section, two techniques are presented that aim to keep a client device in sync with a given email account, meaning that the set of messages on the client device is the same as that in the given email account.

IMAPv4Rev1 clients use a state-comparison-based synchronization technique to be in sync with an email account. This technique requires the client to ask the server for information regarding all the folders and all the messages in each folder stored on the server. The client must then compute the difference between the server state and the client device state, and make all necessary changes so that the client device state matches the server state. An example of the interaction between the client and server in the IMAPv4Rev1 protocol for performing a state-comparison-based sync follows. This is described in more details in [IMAP-DISC].

First, the client must retrieve the folders from the server. The client should issue LIST to figure out which folders has to be retrieved. It than uses LSUB to determine which folders are subscribed. For example:
C: A002 LIST “” “%”
S: * LIST (\Noinferiors) “/” “Drafts”
S: * LIST ( ) “/” “Friends”
S: * LIST (\NoInferiors) “/” “INBOX”
S: A002 OK completed
C: A003 LSUB “” “*”
S: * LSUB ( ) “/” “Drafts”
S: * LSUB ( ) “/” “Friends”
S: * LSUB ( ) “/” “INBOX”
S: A003 OK LSUB completed

Note, that the client should not use LIST“”*, as it might cause too much data to be returned as discussed in [RFC2683] in more detail.

The client must compare its folders with the responses of the command above. If it does not have a folder, it must create that folder on the client device. If there is a folder on the device that is not in any of these responses, then the client must delete that folder. In order to avoid loosing changes performed on the client, the client should apply its changes first. In case when the client has changes to a folder that was deleted on the server, it should ask the user whether the changes should be uploaded to a different mailbox or be discarded (or be configured to automatically do one of the two). Next, the client needs to make sure that the emails in each of its folders match the server. It performs a SELECT and then a FETCH command for each folder. A sample of a SELECT and FETCH command for the inbox is as follows:
C: A003 SELECT OX”
S: * 60 EXISTS
S: . . . more untagged responses with information about the folder
S: A003 OK SELECT completed
C: A004 FETCH 1:* (FLAGS UID)
S: * 1 FETCH (FLAGS (\Answered) UID 120)
S: * 2 FETCH (FLAGS (\Seen) UID 121)
S: . . . flags for messages with message sequence numbers 3-59
S: * 60 FETCH (FLAGS ( ) UID 250)
S: A004 OK FETCH completed

The client must go through the full list of email messages in each folder. It must download an email message from this list if it is not already on the client. Any changes to the mutable flags a message must be reflected on the server using IMAP STORE command. Also, the client should remove any emails on the client device not in this list. After performing these operations, the client is in sync with the server.

Another technique is event-based synchronization. Event-based synchronization is used to keep the client device in sync with the server. This method requires that the client has been fully synchronized with the server at some earlier point. In the IMAPv4Rev1 protocol, the client must perform a state-comparison-based sync when it selects a folder, but then it can use event-based synchronization to keep itself in sync after that. Although event based synchronization cannot totally replace state-comparison-based synchronization, it is a faster alternative for the client to maintain synchrony when the server is capable of change tracking for a client.

In event-based synchronization, the server keeps track of what changes have occurred to the email account that are not yet reflected on the client device. Such a change is called an event. When the client finishes processing all events since the last time it was in sync with the server, it is again in sync with the server. Event-based synchronization is particularly effective when the server can push events to the client for immediate processing. In this case, there are likely to be only a small number of events the client needs to process at one time.

Also, when a Lemonade client drops a connection or accidentally disconnects the server can retain the session and cache all events during the time the client is disconnected. When the client reconnects it does not need to perform a state-comparison-based synchronization all over again, and the server sends the list of pending events to the client

The Lemonade server MUST support Server-side filtering as described in [NOTIFICATIONS].

The Lemonade server MUST support the rich set of extra functionality over the IMAP server to support extra features for a mobile client described as Lemonade Command Extensions in [EXTENSIONS]. These include:

[1] Compression ?onade CS Profile allows for compression of responses to a command. Preliminary testing results shows significant performance results when the response to FETCH FLAGS or header information are compressed. Details are found in [EXTENSIONS].

[2] Sending emails—The Lemonade server can be used to send email, thus eliminating the need for the Lemonade client to connect to a separate SMTP server. When interfacing with a server that supports LEMONADEDELIVER as discovered via CAPABILITY commands as described in [Extensions], this is the mechanism that SHOULD be used. Otherwise, the client is expected to implement the Lemonade Pull Model.

[3] Support for unstable mobile connections ?er a client drops a connection, the Lemonade server can temporarily maintain the session for the mobile client. During this time, the server caches any events concerning the mobile responsitory while the client is disconnected, which it can then send to the client upon reconnection.

[4] Longer periods of inactivity tolerated—A Lemonade server should wait at least 24 hours before logging out an inactive mobile client and ending its session which may lead to Deny of Service.

[5] Attachments forward/reply behavior—When forwarding/replying to a message from the Lemonade client, the end user may choose to reattach the original's message attachments by just specifying the UID of the original message and specifiers for the required bodyparts. The client need not download the attachments of the original message itself. This is an expected server behavior. It may also be implemented following the Lemonade Pull Model.

[6] Attachments conversion—The Lemonade server can convert attachments to other formats to be viewed on a mobile device. This is an expected server behavior.

[7] PIM—The protocol also provides support for updating personal information on a client device, even when these changes are initiated from another client (i.e. a personal assistant connects to an end user's account from a desktop and changes contact information.) These additional uses are especially useful for mobile devices, where end users need up-to-date information on the fly such as calendaring and address book information.

Mobile operators usually charge users for the time their mobile client gets connected to the Internet and/or for the amount of information sent/received. Thus a mobile client should minimize time it stays connected to its mail server, which suggests that it should disconnect and reconnect frequently.

Also, it is possible that the mobile client unexpectedly leaves area of connectivity, which will require that the client reconnects when connectivity returns.

IMAP can be verbose. Usually, in order to synchronize a client with a server after a disconnect, the client needs to issue at least the following commands: LOGIN/AUTHENTICATE, SELECT and several FETCH commands (see [IMAP-DISC] for more details). Thus, there is a desire to have a quick reconnect facility in IMAP, which will give a mobile client ability to resume a previously abandoned session, without the need to perform the full synchronization sequence as described above.

For mobile clients, the Lemonade Profile exchanges may be transported on HTTP as described in [HTTPBINDINGS].

A Lemonade server MUST responds to all IMAPv4Rev1 commands. A compliant Lemonade server must implement all the commands in IMAPv4 Rev1, with the revisions described in [NOTIFICATIONS] and [EXTENSIONS].

The mobile optimization of the Lemonade profile calls for the same security requirements for an in-response and inband connectivity mode as IMAP. For the outband connectivity mode, servers should use encryption methods for notifications if sensitive information is included in the payload of that notification. When an implementation of Lemonade Mobile Profile is proxy-based, this may create new security issues. These issues are discussed in detail in [EXTENSIONS], because the issues are dependent on the implementation of this protocol rather than inherent to the protocol itself.

Lemonade server to client notifications provides some extensions to the IMAPv4 Rev1 protocol [RFC3501] for optimization in a mobile setting, aimed at delivering extended functionality for mobile devices with limited resources. These notifications support pushing crucial changes actively to a client, rather than requiring the client to initiate contact to ask for state changes.

The Lemonade Server to Client Notifications extends IMAPv4 Rev1 [RFC3501]. The client devices are assumed to be wireless with limited resources. However, this should not be seen as constraining. The Lemonade Server to Client Notifications can be bound to any transport protocol for inband and outband connectivity. These notifications inform the client of changes in an end user's mailbox and define what events and conditions generate notifications, as well as how the server will inform the client of these notifications. In addition, it covers how the client will process these notifications to maintain email synchrony.

The Lemonade profile and Lemonade Server to Client Notification protocol is meant to support mobile client devices with memory and connectivity constraints. Due to these constraints, an end user may want to specify filters to limit the number of notifications sent. These filters separate their emails into different sets that the server should handle differently. All end users have a complete repository, which includes all their email messages that are stored on a server. The end user may want to receive a small subset of these messages on their client device, which are to be included on the mobile device. The messages on the device are split further into two categories, lower priority messages that the user chooses to wait for until it can poll the server and higher priority messages that the user would like to be notified of as soon as possible by the server. All three repositories have the same set of folders.

Formally, a repository consists of a set of folders, and each folder has both a name and a set of messages associated with it. While the three repositories all have folders with the same name, there may be different messages in them. The complete repository consists of all folders of an end user and all the associated emails for each of those folders. Messages in the complete repository that pass the view filter make up the poll repository. An end user can specify exactly one view filter per folder per device. In addition, there is a second layer of filtering, called priority or notification filters, and there is exactly one priority filter per folder per device. The push repository is the set of all the messages in the complete repository that pass both the view and the priority filters. The filter and repository model is shown in FIG. 5.

When the client connects to the server and polls for messages, it can determine what changes have occurred to messages that passed the view filters. Whenever an event occurs to a message that passes the view and priority filters, the server actively pushes a notification to the client. Lemonade Server to Client Notification assumes extensions of IMAP with the same basic model, where the client connects to the server to open a session to access its email account. A Lemonade client may fetch the contents of the email account or make changes to it just as in IMAP.

A Lemonade server should support multiple mobile devices for each email user, and should allow each device to have one unique event filter and a set of view filters and priority/notification filters. The server only needs to support one connection per mobile device for each email user. A mobile client connects to the Lemonade server by supplying its LOGIN information, and then must inform the server of this mobile client's device ID, which is some unique identifier for the client device. The server and client should agree on what convention to use for this ID, and it could be a hash of IMEI. If no device ID is given, then a regular IMAP session is initiated. The LOGIN information is used to specify a user, while the device ID is needed to specify the mobile client. Associated with the user and device ID is exactly one view filter and exactly one priority/notification filter for each folder. These filters are saved and thus persist across Lemonade sessions. Filters can be modified when a Lemonade session is open.

View filters and priority/notification filters are used to filter out email messages which match certain criteria. If an email passes through the view filter, it is stored in the mobile repository. The syntax for defining a view filter or notification filter includes any combination of most of the search criteria as defined for the SEARCH command of IMAP, in Section 6.4.4 and 7.2.5 of RFC 3501, or a days filter. The days filter filters messages received starting a certain number of days before the current day. The ALL search criteria, when used alone, means that every email event satisfies the criteria. By default, view filters are set to ALL. Whenever a view filter is modified, the client needs to perform a state-comparison-based sync to keep in sync with the mobile repository since the messages in the mobile repository may have changed.

Priority/Notification filters are used to select emails in the mobile repository which match certain criteria. If an email passes through the notification filter, it is stored in the push repository. The syntax for defining a priority/notification filter is discussed below. By default, priority/notification filters are set to NOT ALL to reduce default traffic at the cost of some delays. Because the view filter defaults to ALL and the priority/notification filter to NOT ALL, the mobile repository will mirror the complete repository, but none of the messages are added to the push repository. This implies that the default behavior is equal to the IMAPv4 Rev1 model.

The client does not need to do anything after it resets a priority/notification filter or event filter, instead the server should then only send out notifications that correspond to the most up-to-date filters.

The syntax for defining a priority/notification filter is ALL, NONE, or NEW. A priority/notification filter applies for all folders in a push repository.

ALL—All message events concerning messages of the push repository will be sent to the client, such as if the message becomes seen or deleted.

NONE—No events should be pushed to the client.

NEW—Only events that concern new messages arriving to the push repository should be pushed to the client.

This one event filter applies for all folders.

There are three connectivity models for Lemonade Server to Client Notifications, depending on the capabilities of the Lemonade server, the client, and the connection available between them. These models include in-response, inband, and outband. It is explicitly stated in what situations these three connectivity models arise.

The in-response binding scenario is the most basic one and implements the poll model. In this case the client initiates the commands to the Lemonade server and the server responds to client commands with events. In this case there is no need for a persistent connection between the client and the server. The client opens a connection only when it needs to send commands to the Lemonade server, and that is the only time it is notified of new events. An In-Response Connection is shown in FIG. 6.

An in-response connection can occur in several situations:

[1] HTTP/HTTPS binding

Server Requires: HTTP/HTTPS listener for IMAPv4

Client Requires: HTTP/HTTPS client with IMAPv4 processing [2] TCP Binding

Server Requires: IMAPv4

Client Requires: IAPv4 +no IDLE

The inband binding scenario corresponds to a reliable push model. In this case the server pushes events to the client whenever they occur. To do so, it must have a reliable means of communication with the client, and the client should be ready to accept such notifications. In this case, there needs to be a persistent connection between the client and the server so that the server can push an event at any time. The client may optionally issue a request to retrieve more information concerning an event. An inband connection is shown in FIG. 7.

An inband connection can occur in the following situations:

[1] TCP Binding, Always connected, IDLE

Server Requires: IMAPv4+IDLE

Client Requires: IMAPv4+IDLE, constant TCP connection

[2] Any other persistent two-way connection

Server Requires: IMAPv4+IDLE

Client Requires: IMAPv4+IDLE, constant connection

The outband binding scenario corresponds to an unreliable push model. In this case the server pushes events to the client whenever they occur, to the best of its ability. To do so, it should be able to send messages to the client without the need for a persistent connection. However, the outband channel can possibly lose and reorder messages, and there are no timing guarantees. Examples of out-band channels include SMS, JMS, WAP Push, and UDP. As in the inband scenario, the client may optionally open a Lemonade session over an inband or in-response connection and send a command as a result of receiving an event. An outband connection is shown in FIG. 8.

Outband connectivity occurs in the following situations:

[1] A notification service from the server to the client

Server Requires: A notification generator.

Client Requires: A notification processor.

Whenever a client device opens a new session, it must perform a state-comparison-based sync with the email server so that its state is the same as the mobile repository. Since the client has no way of directly detecting only changes to the repository since the last login, it needs to retrieve information about every message in the mobile repository and calculate the changes itself. After that point, the client can use event-based synchronization to keep the device in sync.

The Lemonade server can issue a session and track changes to a selected folder for the duration of a session. Until the session is expired, the server must log all events that occur while a client is offline. This way, if the client temporarily loses a connection, it does not have to worry about missing any events and needing to perform another state-comparison-based sync. A client does have the option though to prematurely end a session by issuing a LOGOUT command. Additionally, Lemonade clients can remain inactive for at least twenty four hours without being logged off the server and without the session expiring.

The client can receive the following untagged responses from the server using the following syntax for example in message events sent during an inland and in response mode:

[1] The client receives an EXISTS/RECENT event from the server indicating a new message.

S: * 501 EXISTS

S: * 1 RECENT

Next, the client retrieves this new message using a FETCH command.

C: A02 FETCH 501 (ALL BODY[ ])

S: * 501 FETCH . . .

S: A02 OK FETCH completed

[2] The client receives an EXPUNGE event from the server from a message has been permanently removed from a folder.

S: * 25 EXPUNGE

The client deletes this message from the client device, as it has been removed permanently from the folder. The client does not need to send any command back to the server.

[3] The client receives an untagged FETCH event from the server, which can contain just FLAG information if the event is regarding an old message or possibly other information if the event is regarding a new message. This event is received if a message's flags are changed, or in response to a new message if the user's preferences are set to do so.

S: * 101 FETCH (FLAGS (\Seen \Deleted))

The client saves the information contained in this response accurately in the client device.

The Lemonade Server to Client Notifications also define events to be sent by the server to the client. These events notify the client when there are changes to messages that match an end user's view filters and notification filters, as well as any changes to a client's email folders.

The UID of email messages MUST not change across sessions. Changing the UID of email messages requires a heavy computational burden on the mobile client, so the server should avoid doing so. The UID of email messages MUST not change for the duration of a session.

In a Lemonade session, the client can only access messages in the mobile repository. This affects the messages returned by FETCH, UID FETCH, etc. Message sequence numbers reflect the relative position of messages within the given folders of the mobile repository, so the message sequence number of an email while logged in to Lemonade may also differ from IMAP. When returning information about the email account, only messages in the mobile repository are taken into account.

The server should implement the IDLE command from RFC 2177. When the client issues this command, the server can push changes to a folder to the client. The server may replace the EXISTS/RECENT message with an untagged FETCH command as specified in [EXTENSIONS]. The client should fire this command while in-session to enter inband mode, where the server will actively push notifications to the client.

The LEMONADESETPREF command is described in [EXTENSIONS]. It allows a user to define certain configuration parameters, while the LEMONADEGETPREFS command allows a user to retrieve the configuration values. Any server that implements these commands must respond with LEMONADEPREF as one of the capabilities in response to a CAPABILITY command. It must also announce the values these parameters can be set to in the LEMONADEPROVISION command (See [EXTENSIONS]). These parameters affect how outband notifications are sent to the client, as well as the format for sending new event notifications. If the server supports LEMONADEPREF they are required to support all of the following preferences with at least one value to set each preference to. They are described in [EXTENSIONS].

The LEMONADEFILTER command allows users to set up view filters and priority/notification filters. LEMONADEFILTER can be fired when the state is AUTHENTICATED or SELECTED. The first argument to this command is the folder that that filter should be applied to, or “ALL” for all folders. Next the user specifies “V”, “N”, or “B” to set either a view filter or a priority/notification filter, or both. Following this, it must specify the filter criteria using a combination of search criteria as defined for the SEARCH command of IMAP, in Section 6.4.4 and 7.2.5 of RFC 3501, or the days filter. The ALL search criteria, when used alone, means that every email message satisfies the criteria. Or it can specify “V” or “N” to get a view filter or priority/notification filter. In this case, the last argument is “GET” to retrieve the filter. By default, view filters are set to ALL, while priority/notification filters are set to NOT ALL. This means that the mobile repository includes all the messages in the complete repository, but none are pushed to the client, which is the IMAPv4 Rev1 model. Exactly one view filter and one priority/notification filter is associated with each folder for each device. When a new view filter or priority/notification filter is created, it replaces the previous filter for that folder. When a view filter is modified, the client needs to perform a state-comparison-based sync on the client in order for the device to be in sync with the mobile repository. The server always sends only notifications that correspond to the most up-to-date view filters and priority/notification filters. All filters persist across Lemonade sessions; once set, a filter on a folder applies until the user changes it.

Lemonade introduces a filter, the day's filter, which allows a user to specify from how many days before today it would like to see emails. To see only today's email, a 0 should be used for the int.

lemonadefilter_cmd=tag SP “LEMONADEFILTER” SP (“ALL”/folder) SP ((“V”/“N”/“B”) SP lemonadefilter_criteria)/((“V”/“N”) “GET”)

lemonadefilter_criteria=(IMAPv4Rev1_searching_criteria/days_filter)

[SP lemonadefilter_criteria] days_filter=“DAYSBEFORETODAY” SP int

Valid States: AUTHENTICATED or SELECTED

Responses: untagged responses: lemonadefilterGet_resp

lemonadefilterGet_resp=“*” SP “LEMONADEFILTER” SP folder SP (“V”/“N”)

lemonadefilter_criteria

Result: OK—filter created

NO—can't create the filter

BAD—invalid arguments

Example: The client creates a priority/notification filter for all messages in the Inbox from “John” since Jun. 1st, 2003.

C: A001 LEMONADEFILTER INBOX P SINCE Jun. 1, 2003 FROM “John”

S: A001 OK LEMONADEFILTER completed

Example: The client asks for the view filter for all the folders.

C: A001 LEMONADEFILTER ALL V GET

S: * LEMONADEFILTER˜/INBOX V ALL

S: * LEMONADEFILTER˜/TRASH V NOT ALL

S: A001 OK LEMONADEFILTER completed

Example: Stop notifications on a particular device, fired while in AUTHENTICATED mode.

C: A001 LEMONADEFILTER ALL P NOT ALL

S: A001 OK LEMONADEFILTER ALL P NOT ALL completed

The protocol calls for the same security requirements for an in response and inband connectivity mode as IMAP. For the outband connectivity mode, servers should use encryption methods for notifications if sensitive information is included in the payload of that notification. When an implementation of Lemonade is proxy-based, this may create new security issues because the issues are dependent on the implementation of this protocol rather than inherent to the protocol itself. The event payload for a Lemonade session follows the general format explained above and is in clear text.

The suggested payload for notifications is that suggested by the OMA, see [OMA-EN]. This notification informs the client that some push event has happened on the server, so it must connect to fetch the information. When the client finally connects, the Lemonade server has opportunity to send other pending events for this client. Example: new message arrives on the server and this is notified via outband.

S: pushes SMS with the following text:

<emn mailbox=“mailat:joe@foo.com”

timestamp=“2004-02-20T06 :40: 00Z”>

</emn>

C: needs to connect and send any command to get the pending events and act upon them.

C: A00 Login joe password

S: * SESSION SELECTED

S: * FOLDER INBOX

S: * 100 EXITS

S: * 87 EXPUNGE

S: * 90 FETCH (FLAGS \Seen)

S: A00 OK LOGIN completed

C: must now act on the events on the order they are received, meaning, first perform a FETCH to get new message, then expunge message 87 and change flags of message 90.

Each time a client logs into a new Lemonade session, it must perform a state comparison-based sync. To synchronize with the server, the client needs to fetch all the new messages, and all the flags of the old messages. The client has N messages in a given folder with highest UID=X and is disconnected from the Lemonade server. It connects to the server and performs the following command:

First, it retrieves all the new messages.

C: A01 UID FETCH X+1:* ALL

S: * m FETCH . . .

S: . . . <more new messages if they exist>

S: A01 OK FETCH completed

The client stores all this information on the device and displays it. Next, it wishes to sync up the old messages.

C: A02 FETCH 1:m−1 (UID FLAGS)

S: * 1 FETCH (UID 3242 FLAGS (\Seen . . . ))

S: . . . <info for 2 through n−1>

S: * n FETCH (UID 3589 FLAGS (\Seen . . . ))

S: A02 OK FETCH completed

During a Lemonade session, the client will receive events in the form of untagged EXISTS, RECENT, EXPUNGE, or FETCH responses. The client must respond to these events. Sometimes, it will receive these events by polling, by issuing a Lemonade command, such as NOOP. It can also use IDLE so that the server can push events to the client. The example following shows how the client acts during an IDLE command, but it should also take the same actions (minus firing and exiting IDLE mode) when it receives these events through polling. A client can choose to issue an IDLE command to get events pushed to it, or it can receive events from polling using NOOP or any other IMAP command.

First the client issues the IDLE command:

C: A02 IDLE

S: +Ready for argument

Now the client can receive any of the three following untagged responses from the server.

When the client receives an EXISTS/RECENT response from the server:

S: * 501 EXISTS

First, the client must exit from this IDLE command.

C: DONE

S: A02 OK IDLE completed

Next, the client retrieves this new message using a FETCH command.

C: A02 FETCH 501 ALL

S: * 501 FETCH . . .

S: A02 OK FETCH completed

The client returns to IDLE mode by issuing another IDLE command.

C: A03 IDLE

S: +Ready for argument

When the client receives an EXPUNGE response from the server:

S: * 25 EXPUNGE

The client deletes this message from the client device, as it has been removed permanently from the folder. The client can remain in IDLE mode.

When the client receives an untagged FETCH response from the server, either signally a flag change to an old message or a new message:

S: * 101 FETCH (FLAGS (\Seen \Deleted))

The client updates the information on the device for this message appropriately.

The Internet Society has also proposed solutions to handle lost calls in drafts of ietf-lemonade-reconnect and ietf-imapext-condstore the disclosures of which are incorporated herein by reference. The proposals must be used in combination, however, there are several limitations that make the solution unacceptable.

The present invention utilizes the concept of the IDLE command which is well established and broadly used to solve the problem of lost connections. The extension of the present invention is an unobvious improvement to an already used approach and overcomes the problems of prior art approaches.

### SUMMARY OF THE INVENTION

The present invention provides that while a mobile device is connected in an IDLE session on an IMAP mail server the mail client will be able to provide definite acknowledgements to the server as to whether it has received a particular response. If the client is disconnected involuntarily and upon reconnection it will be able to receive any responses that it may have missed during its disconnection and any response it had not acknowledged while connected. This will allow the client to thus avoid doing a deep synchronization after each reconnect.

The present invention performs two main functions in order to avoid having the client perform deep synchronization. One, it clearly defines the set of information sent to the client during a reconnection, and two, it defines the behaviour that both the server and the client have during an involuntary loss of connection and the subsequent reconnection.

There are numerous advantages to the invention including that it provides a way to avoid a deep synchronization after each involuntary disconnect.

### DESCRIPTION OF THE DRAWINGS

FIG. 1 is a functional block diagram of a Lemonade Pull Model.

FIG. 2 is a functional block diagram of a Lemonade Client-Server Profile Model.

FIG. 3 is a functional block diagram of a Lemonade Periodic Poll Model.

FIG. 4 is a functional block diagram of a Lemonade Push Model.

FIG. 5 is a functional block diagram of a Lemonade Filter and Responsitory Model.

FIG. 6 is a functional block diagram of a Lemonade In-Response connection.

FIG. 7 is a functional block diagram of a Lemonade Inband connection.

FIG. 8 is a functional block diagram of a Lemonade Outband connection.

FIG. 9 is a flowchart showing the major functional steps for acknowledged delivery embodying the invention.

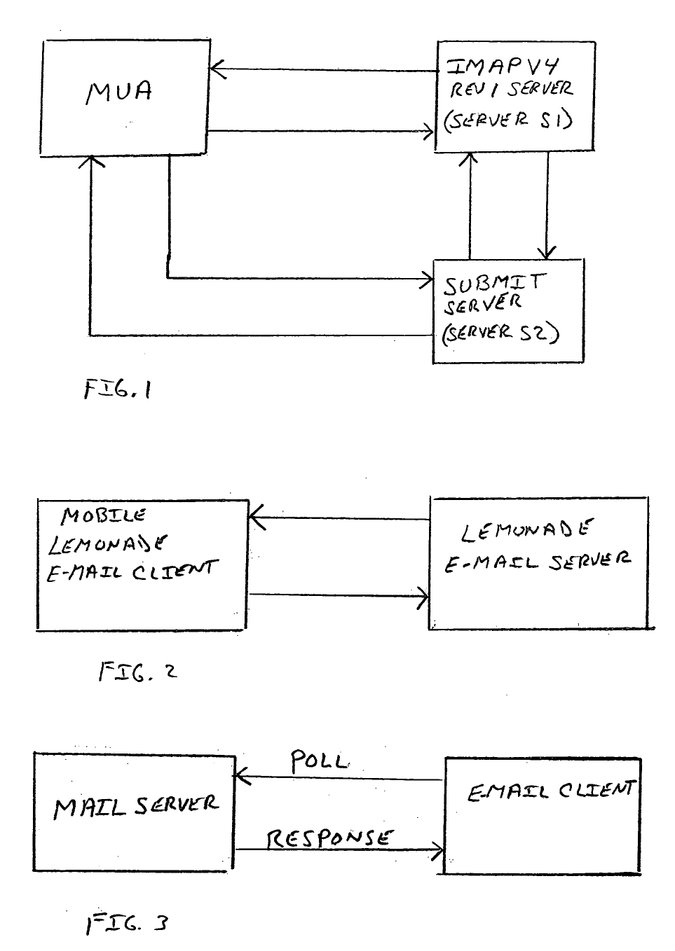

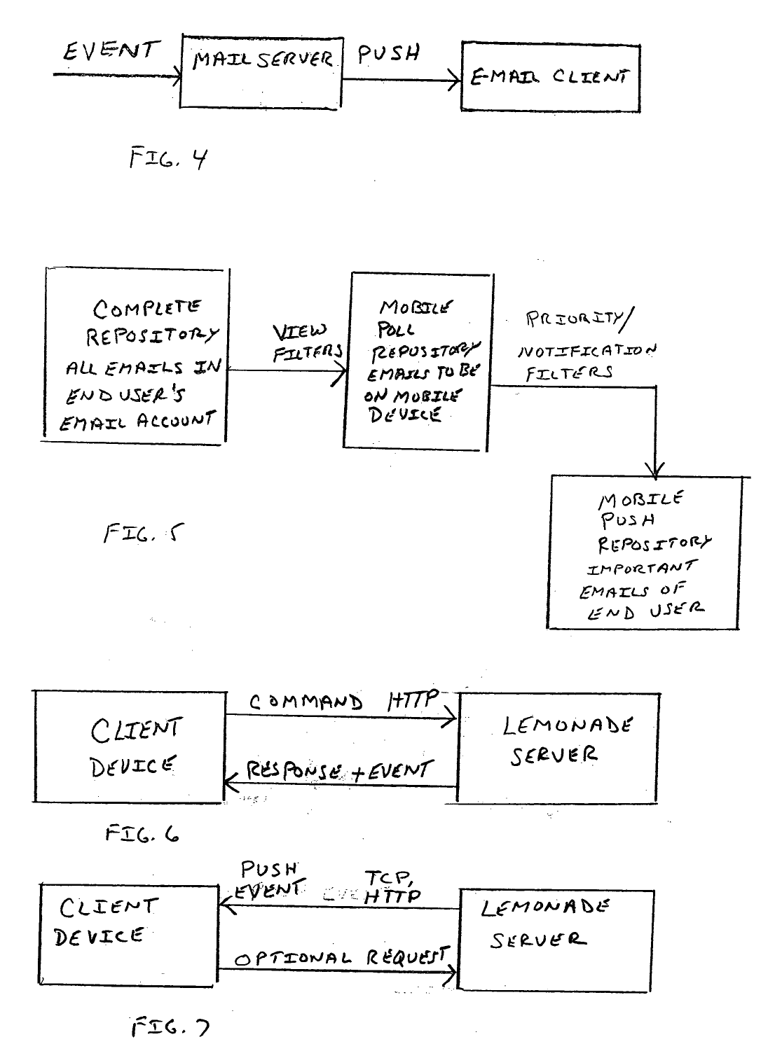

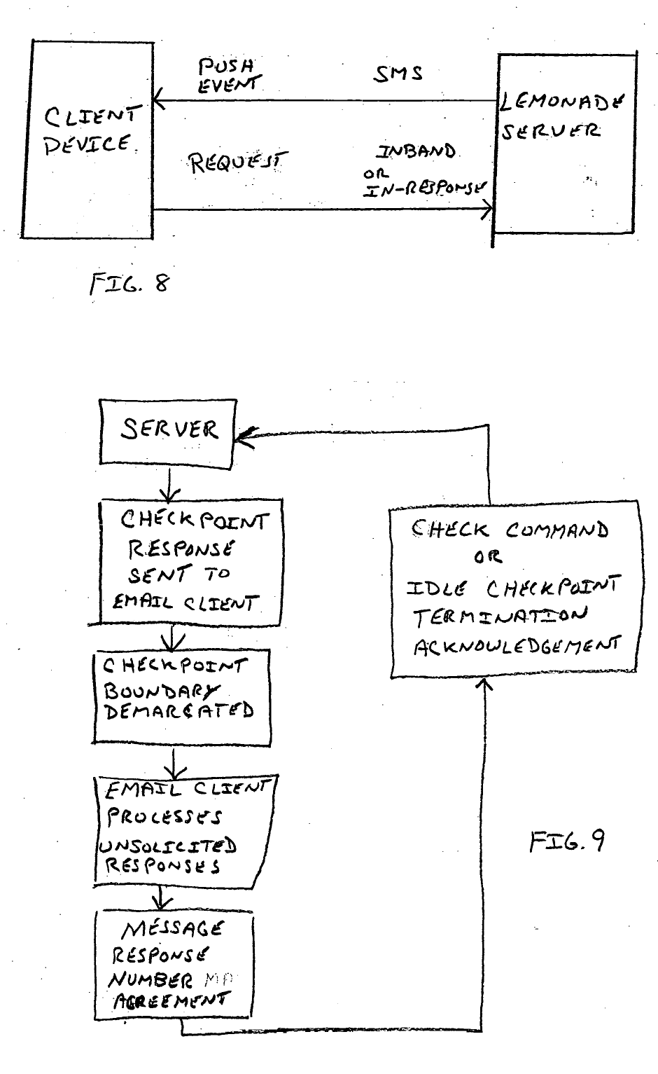

### DESCRIPTION OF THE INVENTION

The present invention provides IMAP extension that aids in allowing a client to maintain mailbox synchronization without performing a deep syncronization after each connection. The goal is to minimize, but not eliminate, the need for deep synchronizations. The extension defines a way for a client to receive and acknowledge state change responses from the server.

The CHECKPOINT extension is present in any IMAP implementation that returns “CHECKPOINT” as a supported extension in the CAPABILITY response. Clients that are connected over long thin connections may have a need to reduce the overhead of performing mailbox synchronizations. Ideally some approach that allows the cost of the synchronization to be distributed over time and reduces the redundant retrieval of information would reduce the burden of synchronization on the client.

This extension provides a mechanism to allow the client to acknowledge to the server that unsolicited responses have been received and processed. Prior to the server sending mailbox state change information via unsolicited responses it will send a new CHECKPOINT response code to demarcate a checkpoint boundary. The client will then process unsolicited responses until at some point it decides to acknowledge to the server that all unsolicited responses since some message response number are committed. This acknowledgment is communicated to the server via an extended CHECK command or through an IDLE CHECKPOINT termination. Each unsolicited message sent from the server to the client over an idle checkpoint session will contain a response number identifying the message. The major functional steps of the acknowledged delivery are showing in the flowchart of FIG. 9.

There are two distinct mechanisms for acknowledging a checkpoint to allow clients to take advantage of either a multiple session design or a single session design. A CHECK command could be used in a multiple session design, and an IDLE CHECKPOINT termination could be used in a single session design.

The mechanism works within the context of the IDLE command. There is no strict requirement to be part of the IDLE sequence, but doing so provides a context in which the server can restrict the need for the enhanced response queuing that will be needed to implement the extension. It also restricts the scope of when messages are identified by a response number.

### Definitions as Used in the Disclosure

Full Synchronization

Client queries server for all information pertaining to a set of folders. The assumption here is that the client has zero valid information about a mailbox. This would occur at the very first connection or maybe after a UIDVALIDITY change.

Deep Synchronization

Client queries server for all changes that have occurred since last synchronization. This is typically less costly then a full synchronization because the client retains some information from a previous synchronization.

Response Number

A non-zero unsigned 32-bit integer. The response number is chosen by the server and MUST be monotonically increasing value. The value is used by the client to keep track of unsolicited responses that are currently queued on the server. Section 2.2 has details of the BNF.

### IMAP Protocol Changes for the Invention

CHECKPOINT Response Code

The invention adds a new CHECKPOINT response code. The CHECKPOINT response code MUST only occur in an unsolicited untagged response during an IDLE session or as part of the response to the CHECK command. A server supporting the checkpointing mechanism during an IDLE command MUST send a CHECKPOINT response code as part of the first response sent on an IDLE connection. Additional CHECKPOINT response codes will be sent after this as determined by the server.

The response code is followed by a checkpoint response number. The response number is chosen by the server and MUST be a monotonically increasing integer value. This value is used by the client to keep track of the unsolicited responses that are currently queued on the server. The value plus one is used by the server as the initial message response number appended to the next unsolicited message.

If the response number is followed by the “CONTINUED” keyword then the client should treat this response as an indication there are pending response lines queued up and waiting to be sent. If the CONTINUED keyword is used then the response number MUST be the response number of the original OK CHECKPOINT that started the sequence. The server MUST send these to this idle connection before any new responses are sent. These pending responses may or may not have already been sent. The client MUST be able to handle duplicate response strings, i.e responses with already received response numbers since the last checkpoint.

If the response code is part of a NO response then the client MUST terminate all IDLE CHECKPOINT sessions and SHOULD re-issue the IDLE CHECKPOINT command to re-establish queuing. The client SHOULD perform a deep mailbox synchronization due to this NO response.

Once a server has sent a NO response containing the CHECKPOINT response code all queuing for the current authentication session MUST stop until a new IDLE CHECKPOINT session becomes active.

### EXAMPLE 1

S: * OK [CHECKPOINT 10540] Initial Idle Checkpoint

In this example the next unsolicited message will contain the response number 10541.

### EXAMPLE 2

S: * OK [CHECKPOINT 10540 CONTINUED] Continuing After Termination

In this example the following unsolicited message set to the client will contain the response numbers 10541 . . 10541+N, but some subset of this will have already been sent to the client.

### EXAMPLE 3

S: * NO [CHECKPOINT 10540] Checkpoint Failed, Queue Terminated

In this example the client SHOULD perform a deep synchronization.

Message Response Number Addition

Each unsolicited message sent from the server to the client over an idle checkpoint session MUST contain a response number identifying the message. For responses containing CHECKPOINT response codes the response number of the message is the CHECKPOINT response number. The response number is only valid until the queue is terminated by the server. The server MAY reuse response numbers after it sends a NO response with a CHECKPOINT response code. The server MUST maintain continuity of response numbers after it sends an OK response with a CHECKPOINT response code.

The response number MUST be appended as the last parsable token in the response. The BNF is: response-data-nocrlf=“*” SP (resp-cond-state/resp-cond-bye/mailbox-data/message-data/capability-data)

seqnumpart=“(“number”)”; See [IMAP4] for definition of “number” iresponse=response-data-nocrlf SP seqnumpart response=iresponse CRLF

### EXAMPLE 1

S: * 4 FETCH (FLAGS (\Recent) UID 789) (10541)

If the client detects gaps in the response number sequence then the client MUST perform a checkpoint of the last number of the last contiguous sequence. This will cause the server to reset the response number and resend the messages if necessary.

IDLE Command Extension

Arguments: CHECKPOINT

Responses: A continuation response which is an open prompt indicating the client can send “DONE” to terminate the command. Immediately after the continuation response an untagged response containing a CHECKPOINT response code MUST be sent.

The client MAY also send a “PING” continuation line to indicate to the server that it may resets its timeout timer. A continuation response is then sent by the server.

Result: OK—IDLE completed after client sent “DONE” or “DONE CHECKPOINT”

NO—Failure: the server will not allow the IDLE command at this time.

BAD—Command unknown, arguments invalid or an invalid response number.

An IDLE command with the CHECKPOINT argument indicates to the server that it is to use the checkpoint facility to track the unsolicited responses being sent to the client. The tracking is done via a queuing mechanism that is outside the scope of this disclosure.

Upon reconnection any queued responses associated with this authentication session that are in the PENDING state MUST be sent on the first IDLE CHECKPOINT connection. Just prior to these messages being sent a CHECKPOINT CONTINUED response code must be sent on this idle connection.

If a client sends a “DONE” continuation string with no additional arguments then the server MUST drop any queued responses that have not been acknowledged either via the CHECK command or an IDLE command checkpoint termination. In this case the server MUST send an untagged NO response containing a CHECKPOINT response code indicating the current queued response set has been dropped. The NO response MUST be sent to all IDLE CHECKPOINT sessions. If the client sends a “DONE CHECKPOINT <seqnum>” continuation string the IDLE session is terminated and the server will behave as if a “CHECK CHECKPOINT <seqnum>” command was sent.

All queued responses MUST be dropped and a new untagged unsolicited CHECKPOINT response code MUST be issued when the current set of queued responses are acknowledged.

CHECK Command Extension

Arguments: CHECKPOINT keyword followed by a response number.

Responses: If the checkpoint is successfully committed an OK response containing a CHECKPOINT response code. If the checkpoint was not committed then a NO response is returned.

Result: OK—check command completed

BAD—Command unknown, arguments invalid or an invalid response number.

This command extension is used by a client to communicate to the server that it has successfully processed all responses upto and including the specified response number. When the CHECK command is given a CHECKPOINT argument the response number identifies the last message response number the client is acknowledging. The only legal response number is a response number in the set N . . M where N is the response number on the last OK response containing a CHECKPOINT response code, and M is the response number on the last unsolicited response sent on the idle session. The server MAY drop the currently queued set of responses once they are acknowledged by the client.

The command also has the side effect of causing an untagged unsolicited CHECKPOINT response code to be sent on all IDLE CHECKPOINT sessions. This signals the start of a new queued response code set.

### EXAMPLE 1

C: 1 CHECK CHECKPOINT 20897

S: * OK [CHECKPOINT 20897] Checkpoint Acknowledged

S: 1 OK CHECK Completed

### EXAMPLE 2

C: 2 CHECK CHECKPOINT 20897

S: * NO [CHECKPOINT 20897] Checkpoint Failed

S: 1 OK Check Complete

Queuing Mechanism

The response queue maintained by the server is associated with an authentication session. An authentication session is identified when a connection enters an authentication state and terminates when a successful LOGOUT command occurs. In the case of a PREAUTH connection the authentication session is implied in the same external way that the pre-authentication was.

The response queue maintained by the server MUST maintain each queued entry in one of two states—PENDING or ACKNOWLEDGED.

PENDING: The response has been sent on at least one checkpoint idle connection, and has not been acknowledged.

ACKNOWLEDGED: The response has been acknowledged by the client. A client acknowledges a response via a IDLE CHECKPOINT termination or the CHECK CHECKPOINT command.

The server is under no obligation to retain an acknowledged response after this point and MAY drop the queued response at this time.

A queue is terminated or dropped when any of the following events occur on the server:

1) An IDLE command with no CHECKPOINT argument is received on any authentication session associated with this queue. An untagged NO CHECKPOINT response is generated on all IDLE connections.

2) A DONE continuation line with no CHECKPOINT argument is received on any authentication session associated with this queue. An untagged NO CHECKPOINT response is generated on all IDLE connections.

3) A DONE continuation line with a CHECKPOINT argument is received on any authentication session associated with this queue. An untagged OK CHECKPOINT response is generated on all IDLE connections.

4) A CHECK command with a CHECKPOINT argument, and a response number that falls within the legal range. An untagged OK CHECKPOINT response is generated on all IDLE connections.

5) A LOGOUT command is received for the last active connection associated with the queue.

6) After some time out period during which there are no active authentication sessions. The time out period MAY be configurable. How the period is set is outside the scope of this disclosure. A NO CHECKPOINT response MUST be sent on the first IDLE CHECKPOINT connection following a timeout.

The following client scenarios are provided to describe expected behavior on the part of clients in interesting situations to gain a better understanding and appreciation of the invention.

Multiple Client Instance Access

Multiple clients connecting and using the CHECKPOINT facility concurrently has implications beyond just the simple multiple connection situation. When multiple connections are used by a single client instance the knowledge the client has that it is using multiple connections allows it to coordinate behavior between the two connections in fact, this latter situation is the expected behavior of clients.

While multiple distinct client instances accessing the CHECKPOINT facility is discouraged predictable behavior should be defined. This section describes the behavior that SHOULD occur given the possible cases.

Case 1: N Client Concurrent Access to IDLE CHECKPOINT connection

First client has an outstanding IDLE CHECKPOINT connection active. When the subsequent client connects and issues the IDLE CHECKPOINT command it will receive an OK CHECKPOINT response communicating the currently active checkpoint. It will then receive all queued responses from the server.

If any client issues a successful CHECK CHECKPOINT command or an IDLE CHECKPOINT termination then all outstanding IDLE CHECKPOINT sessions will receive an OK CHECKPOINT response code indicating the start of a new checkpoint. The clients then have the option to either accept this as a valid start of a new checkpoint sequence or perform a deep synchronization.

The former choice is a reasonable one if the client has already committed or is able to commit all messages up to the new checkpoint. Only the client knows its situation.

Case 2: Client “Steals” a Continued Checkpoint Response

The server has detected the loss of a client TCP connection and is waiting to send a CHECKPOINT CONTINUED response code. Now, the next IDLE CHECKPOINT session is established by a client that is not expecting a continued session. If a client receives an unexpected continued response it SHOULD terminate the IDLE session with a simple “DONE”, and perform normal connection synchronization.

There is a possibility that a client expecting a continued response may steal another clients continued response. If this is the case then the client should consider this an unexpected response.

Case 3: Racing Checkpoint Terminations

If two clients have active IDLE CHECKPOINT sessions and both send a CHECK CHECKPOINT then both will receive two OK CHECKPOINT responses. Each client MAY then either accept each as a valid start of a new checkpoint sequence or perform a deep synchronization depending on it's internal knowledge of how it processed any unsolicited responses in between the OK CHECKPOINT responses.

Client Information Windows

While it is expected that the client will use a separate connection to run the IDLE command, the concurrent mailbox issue is mitigated by issuing the IDLE command in the Authenticated state and not in the selected state. This will allow a server to avoid having to enforce concurrent access limitations for certain mailbox formats.

Initial Connection Synchronization

In order to avoid windows of missed information a client SHOULD use the following scheme to monitor mailbox state. The following scenario assumes a single client instance.

Connection 1:

Client makes first connection to server and authenticates proceeding to the Authenticated state. Client issues an IDLE CHECKPOINT and begins immediately tracking changes received from the server. In order to avoid the loss of the connection a PING continuation line should be sent by the client.

Connection 2:

Client makes second connection to server and authenticates proceeding to the Authenticated state. Client then performs a deep synchronization of information as required. This second connection can then be used to perform perfunctory IMAP operations as needed by the client while connection 1 remains to monitor the state changes.

Continued Connection Synchronization

When a client connects after an abnormal TCP connection termination it MAY reconnect expecting a CHECKPOINT CONTINUED response code. If the expected response is received the client SHOULD process all unsolicited responses flooded to it and update it's mailbox state.

If the client receives a NO or OK CHECKPOINT response then it has received an unexpected response and SHOULD proceed with normal initial connection synchronization.

Smooth Acknowledgment Using Idle Connection

C: 1 IDLE CHECKPOINT

S: +continuation, PING, DONE or DONE CHECKPOINT <seqnum>

S: * OK [CHECKPOINT 1000] New Checkpoint Delimited

New Mail Arrives

S: * 4 EXISTS (1001)

S: * 4 FETCH (FLAGS (\Recent) UID 789) (1002)

C: PING

S: +Still Here, PING, DONE or DONE CHECKPOINT <seqnum>

Some Client Reads Message 789

S: * 4 FETCH (FLAGS (\Seen) UID 789) (1003)

C: DONE CHECKPOINT 1003

S: 1 OK Idle Complete, Checkpoint Acknowledged

Smooth Acknowledgment Using Check Command

The above example of smooth acknowledgement using idle connection demonstrates a normal non-race condition. This is the case where the messages being sent from the server to the client and the client to the server are received in their entirety, which is purely by chance.

Client Connection One.

C: 1 IDLE CHECKPOINT

S: +continuation, PING, DONE or DONE CHECKPOINT <seqnum>

S: * OK [CHECKPOINT 1000] New Checkpoint Delimited

New Mail Arrives

S: * 4 EXISTS (1001)

S: * 4 FETCH (FLAGS (\Recent) UID 789) (1002)

CHECK Command issued on second connection

S: * OK [CHECKPOINT 1003] New Checkpoint Delimited

Some Client Reads Message 789

S: * 4 FETCH (FLAGS (\Seen) UID 789) (1004)

Client Connection Two.

C: 2 CHECK CHECKPOINT 1002

S: * OK [CHECKPOINT 1002] Checkpoint Complete S: 1 OK Check Complete, Checkpoint Acknowledged

The above example of smooth acknowledgement using check command demonstrates a race condition. This is the case where an acknowledgment and an unsolicited response pass each other in the full duplex channel of TCP.

Client Connection One.

C: 1 IDLE CHECKPOINT

S: +continuation, PING, DONE or DONE CHECKPOINT <seqnum>

S: * OK [CHECKPOINT 1000] New Checkpoint Delimited

New Mail Arrives

S: * 4 EXISTS (1001)

S: * 4 FETCH (FLAGS (\Recent) UID 789) (1002)

Some Client Reads Message 789

CHECK Command issued on second connection

Server sent this response before checkpointing

S: * 4 FETCH (FLAGS (\Seen) UID 789) (1003)

Server sends a CHECKPOINT response code, but it arrives after message 1003, so the server starts a new checkpoint at the last message boundary S: * OK [CHECKPOINT 1002] New Checkpoint Delimited.

Client Connection Two.

C: 2 CHECK CHECKPOINT 1002

S: * OK [CHECKPOINT 1002] Checkpoint Complete

S: 1 OK Check Complete, Checkpoint Acknowledged

Termination With Forced Queue Flushing

C: 1 IDLE CHECKPOINT

S: +continuation, PING, DONE or DONE CHECKPOINT <seqnum>

S: * OK [CHECKPOINT 1000] New Checkpoint Delimited

New Mail Arrives

S: * 4 EXISTS (1001)

S: * 4 FETCH (FLAGS (\Recent) UID 789) (1002)

C: DONE

S: * NO [CHECKPOINT 1000] Queue Terminated

S: 1 OK Idle Complete

Abrunt Termination With Pending Queue

C: 1 IDLE CHECKPOINT

S: +continuation, PING, DONE or DONE CHECKPOINT <seqnum>

S: * OK [CHECKPOINT 1000] New Checkpoint Delimited

New Mail Arrives

S: * 4 EXISTS (1001)

S: * 4 FETCH (FLAGS (\Recent) UID 789) (1002)

Connection dropped via TCP Reset

Some client reads message 789

Client reconnects and re-authenticates

C: 1 IDLE CHECKPOINT

S: +continuation, PING, DONE or DONE CHECKPOINT <seqnum>

S: * OK [CHECKPOINT 1000 CONTINUED] Checkpoint Continued

S: * 4 EXISTS (1001)

S: * 4 FETCH (FLAGS (\Recent) UID 789) (1002)

S: * 4 FETCH (FLAGS (\Seen) UID 789) (1003)

C: DONE CHECKPOINT 1003

S: 1 OK Idle Complete, Checkpoint Acknowledged

Abrupt Termination Due To Timeout

C: 1 IDLE CHECKPOINT

S: +continuation, PING, DONE or DONE CHECKPOINT <seqnum>

S: * OK [CHECKPOINT 1000] New Checkpoint Delimited

New Mail Arrives

S: * 4 EXISTS (1001)

S: * 4 FETCH (FLAGS (\Recent) UID 789) (1002)

Connection dropped via TCP Reset

Some client reads message 789

Client is disconnected due to some timeout period

Client reconnects and reauthenticates

C: 1 IDLE CHECKPOINT

S: +continuation, PING, DONE or DONE CHECKPOINT <seqnum>

S: * NO [CHECKPOINT 1000] Queue Terminated, Time out

C: DONE

S: 1 OK Idle Complete

C: 1 IDLE CHECKPOINT

S: +continuation, PING, DONE or DONE CHECKPOINT <seqnum>

S: * OK [CHECKPOINT 1001] New Checkpoint Delimited

Start listening for fresh events

The invention also clarifies and extends the set of responses that a client may receive while in the idle state. The desire is to allow a client to predict exactly what set of unsolicited responses it can rely on receiving when listening on an idle connection. The IMAPRev4 specification supports unsolicited responses being sent to a client at any time. The IDLE specification defines a way for a client to sit in an idle connection waiting to receive these responses.

The CLEARIDLE extension is present in any IMAP implementation that returns “CLEARIDLE” as a supported extension in the CAPABILITY response.

The current set of IMAP RFCs provide an unambiguous way to deliver unsolicited responses to a client. A client may use these responses to gain information about the current state of the mailboxes on the server. The problem is that the set of responses a client may receive is ambiguous. A client has no way to reliably predict that given a certain state change on the server a response communicating this change will be sent.

The IMAP specification allows unsolicited responses to be sent on a client connection at any time. This extension adds predictability to the set of responses sent by a server during an IDLE session. Predictability is accomplished by stating what responses must be sent as the result of a corresponding event on the server. A new extension is used to allow servers to clearly state if this more rigorous definition of IDLE is adhered to. The IDLE command is a legal command in both the Authenticated and Selected state. While in the Selected state it is intuitive that only responses related to the selected mailbox would be returned. It is not as clear what should be returned while in the Authenticated state. The invention clarifies this. When a response is received while in the Authenticated state it may be that the response alone would be ambiguous as to which mailbox the response pertained to. When this situation occurs an IMAP URL is appended to the response to clarify which mailbox the response is associated with.

IMAP Protocol

The CHECKPOINT extension [CHECKPOINT] MUST be supported if CLEARIDLE is supported. The dictates of this extension only apply while an IDLE CHECKPOINT session is active.

LIST Response

Currently the LIST response occurs as the result of a LIST command. This document modifies the syntax of a LIST response and also defines its occurrence as a legal unsolicited response that could be received on IDLE connections associated with a user.

Two new name attributes are defined in this invention:

\Deleted

The mailbox has been deleted and no longer exists. After a LIST response with this attribute is seen the server will no longer show the named folder in any LIST commands. There MUST NOT be any other name attributes sent along with this attribute.

\Renamed

The mailbox has been renamed. A second LIST response MUST immediately follow indicating the new name.

A server MUST send a LIST response on all idle connections if one of the following events occurs on the server:

1) If a new folder is created a LIST response is sent with all name attributes that apply at the time of creation. The name of the folder MUST be fully qualified.

### EXAMPLE

S: * LIST (\Noinferiors)“/”˜/NewFolder

2) If a folder is deleted a LIST response is sent with only the \Deleted name attribute.

### EXAMPLE

S: * LIST (\Deleted)“/”˜/NewFolder

3) If a folder is renamed two LIST responses are sent. The first indicating the old name and a \Renamed attribute and a second response MUST immediately follow the first indicating the new name.

The \Renamed attribute is very similar to the \Deleted attribute. The reason the \Deleted attribute is not used is to allow the client two distinct processing paths. One for a delete and another for a rename. It is likely that in the case of a delete a more thorough removal of the folder would occur.

### EXAMPLE

S: * LIST (\Renamed)“/”˜/OldName

S: * LIST (\Noinferiors)“/”˜/NewName

FETCH Response

Currently the FETCH response occurs as the result of a FETCH command or as an unsolicited response on an IDLE connection. The invention clarifies exactly what form of response should be sent when the specified events occur on the server.

There are two forms of the FETCH response to be sent while this extension is in play. The first is if the message flag state changes, and the second is if a new message arrives. The response indicates the current state of the message.

Flag State Change

An unsolicited FETCH response with flag and uid data MUST be sent on all IDLE connections.

### EXAMPLE

S: * 8 FETCH (FLAGS (\Deleted) UID 789)

New Message Arrival

An unsolicited FETCH response with envelope, body, flag and uid data MUST be sent on all IDLE connections.

### EXAMPLE

S: * 1 FETCH (UID 34 FLAGS (\Recent) ENVELOPE ( . . . ) BODY ( . . . ))

EXISTS Response

The EXISTS response MUST be sent on all IDLE connections if the size of a mailbox changes. This does not include when the size decreases due to an EXPUNGE.

EXPUNGE Response

The EXPUNGE response MUST be sent on all IDLE connections if a message is deleted from a folder.

Response Clarification

A server supporting the CLEARIDLE extension must send a well defined set of responses depending on which state the server is in. The client must be able to predict that it will receive specific responses on an idle connection given a particular event on the sever.

Authenticated State

If the IDLE command is sent while in the Authenticated state then the following unsolicited responses MUST be sent if the corresponding event occurs on the server.

LIST Response

RECENT Response

EXISTS Response

FETCH Response

EXPUNGE Response

Those that require disambiguation MUST contain an IMAP URL as per the following explanation.

Mailbox Identification Syntax

While in the Authenticated state there is no way to implicitly determine which mailbox the response applies to. While this is not a problem for some responses such as the LIST response it does pose a problem for responses that are mail message specific. The URL syntax standardized [IMAP-URL] for IMAP MUST be used to disambiguate a response when it is required. The following BNF is used for message specific responses:

```
  msgurl = “imap://” iserver “/” imessagepart
        ;See [IMAP-URL] for “iserver” definition imessagepart =
enc_mailbox [uidvalidity] iuid
        ;See [IMAP-URL] for “enc_mailbox” definition iuid =
“/;UID=” nz-number
        ;See [IMAP4] for “nz-number” definition uidvalidity =
“;UIDVALIDITY=” nz-number
        ;See [IMAP4] for “nz-number” definition msgresponse =
“FETCH” / “EXPUNGE”
  msgres-nocrlf = “*” SP nz-number msgresponse
  d1response = msgres-nocrlf SP “(“ msgurl ”)” [SP seqnumpart] CRLF
        ;See [CHECKPOINT] for “seqnumpart” definition
```

### EXAMPLE

S: * 8 FETCH (FLAGS(\Seen) UID 789) (impa://mail/inbox/;UID=789) The following BNF is used for mailbox specific responses:

```
mbxurl = “imap://“ iserver ”/” enc_mailbox
        ;See [IMAP-URL] for “enc_mailbox” definition
mbxresponse = “RECENT” / “EXISTS”
mbxres-nocrlf = “*” SP number mbxresponse
        ;See [IMAP4] for “number” definition
d2response = mbxres-nocrlf SP “(“ mbxurl ”)” [SP seqnumpart] CRLF
        ;See [CHECKPOINT] for “seqnumpart” definition
```

### EXAMPLE

S: * 22 EXISTS (imap://mail/inbox)

Selected State

If the IDLE command is sent while in the Selected state then the following unsolicited responses MUST be sent if the corresponding event occurs on the server.

1. Method, comprising the steps of:
acknowledging delivery of full email state change to mobile email clients after an involuntary disconnect for a mobile device connected in an IDLE session on an IMAP mail server;
sending from the IMAP mail server a CHECKPOINT response to the email client prior to sending mailbox state change information;
demarcating a checkpoint boundary;
processing by the email client of unsolicited responses;
acknowledging to the IMAP server via an extended CHECK command or through an IDLE CHECKPOINT terminations.

2. A system for carrying out the method of claim 1.

3. A software application product comprising suitable program code for carrying out the method of claim 1.
